(19) United States
(12) Patent Application Publication
(10) Pub. No.: US 2011/0197148 A1
(43) Pub. Date: Aug. 11, 2011

(54) APPARATUS AND METHOD FOR PROVIDING NETWORK COMMUNITY SERVICE

(75) Inventors: Young Ho RHEE, Yongin-si (KR); Hyun Joo Kang, Suwon-si (KR); Yeo Jin Kim, Suwon-si (KR)

(73) Assignee: SAMSUNG ELECTRONICS CO., LTD., Suwon-si (KR)

(21) Appl. No.: 12/824,999

(22) Filed: Jun. 28, 2010

(30) Foreign Application Priority Data
Feb. 9, 2010 (KR) 10-2010-0011807

(51) Int. Cl. G06F 3/01; G06F 15/16

(52) U.S. Cl. 715/753

(57) ABSTRACT

An apparatus and method for providing a network community service are provided. A user may register his or her networkable device in a server, and may check contexts of acquaintances in real-time through an online personal networking service. Also, the user may be provided with analysis data related to acquaintances in the same circumstances as the user, and contents may be shared between the user and acquaintances by communicably connecting a device of the user to devices of the acquaintances.

### CROSS-REFERENCE TO RELATED APPLICATION(S)

This application claims the benefit under 35 U.S.C. §119(a) of Korean Patent Application No. 10-2010-0011807, filed on Feb. 9, 2010, in the Korean Intellectual Property Office, the entire disclosure of which is incorporated herein by reference for all purposes.

### BACKGROUND

1. Field

The following description relates to an apparatus and method for providing a network community service, and more particularly, to an apparatus and method for providing a network community service through which a user may register all available devices and may easily recognize context of acquaintances so that an online personal networking service may be used in real-time.

2. Description of Related Art

Mobile devices provide a variety of community web-based services to support personal actions as well as social actions. A web-based service may include, for example, a Social Network Service (SNS) that is a type of online personal networking service. The SNS enables users to record messages on an SNS server using their own mobile devices and to share the messages with each other. Another example of the web-based service may include a service for transceiving contents between two different devices. When a user transmits a photograph stored in his or her mobile device together with a message to a television (TV), the TV may generate a card containing the photograph and message, and may display the generated card. However, a conventional web-based service has only a function of sharing a content such as an image or a moving image, or recording a message.

### SUMMARY

In one general aspect, there is provided an apparatus for providing a network community service, the apparatus including: a display unit configured to display an analysis screen related to acquaintances, the acquaintances in the same circumstances as a user among subscribers logged into an online personal networking service, and a User Interface (UI) generator configured to: receive analysis data, and generate the analysis screen based on the received analysis data, the analysis data being obtained by collecting context information of the acquaintances.

The apparatus may include that the analysis data includes context information of subscribers in the same circumstances as the user among the subscribers logged into the online personal networking service.

The apparatus may include that the analysis data is provided by a server configured to provide the online personal networking service.

The apparatus may further include: a communication unit configured to communicate with the server and devices used by the acquaintances, wherein the server is further configured to: receive the context information of the acquaintances from the devices used by the acquaintances, prepare the analysis data, and transmit the prepared analysis data to the communication unit in real-time.

The apparatus may include that, in response to the acquaintances' and the user's viewing the same content, the analysis screen is further configured to show a result of analyzing a reaction of the acquaintances to the content.

The apparatus may include that the reaction of the acquaintances is analyzed based on sound energy or movement data, the sound energy, or movement data being generated while the acquaintances view the content.

The apparatus may further include at least one of: a sound sensor configured to sense a sound energy of the user, and a photography apparatus configured to sense a movement of the user.

The apparatus may include that, in response to the acquaintances' and the user's performing the same activity, the analysis screen is further configured to show a regional distribution chart of the acquaintances.

The apparatus may include that the display unit is further configured to display a UI containing a list of the acquaintances and information regarding the devices used by the acquaintances.

The apparatus may further include a controller configured either to recommend a conversation scheme to the user based on a context of the user, or to automatically select the conversation scheme, in response to one of the acquaintances' requesting a conversation with the user.

In another general aspect, there is provided a method for providing a network community service in a network community providing apparatus, the method including: receiving analysis data obtained by collecting context information of acquaintances, the acquaintances in the same circumstances as a user among subscribers logged into an online personal networking service, generating an analysis screen related to the acquaintances based on the received analysis data, and displaying the generated analysis screen.

The method may include that the analysis data includes context information of subscribers in the same circumstances as the user among the subscribers logged into the online personal networking service.

The method may include that the analysis data is provided by a server which provides the online personal networking service.

The method may include that the server: receives the context information of the acquaintances from the devices used by the acquaintances, prepares the analysis data, and transmits the prepared analysis data in real-time.

The method may include that, in response to the acquaintances' and the user's viewing the same content, the analysis screen shows a result of analyzing a reaction of the acquaintances to the content.

The method may include that the reaction of the acquaintances is analyzed based on sound energy or movement data, the sound energy or movement data being generated while the acquaintances view the content.

The method may further include: sensing, by a sound sensor, a sound energy of the user, or sensing, by a photography apparatus, a movement of the user.

The method may include that, in response to the acquaintances' and the user's performing the same activity, the analysis screen shows a regional distribution chart of the acquaintances.

The method may further include displaying a UI containing a list of the acquaintances and information regarding the devices used by the acquaintances.

The method may further include, when one of the acquaintances requests a conversation with the user: recommending a conversation scheme to the user based on a context of the user, or automatically selecting the conversation scheme.

In another general aspect, there is provided a computer-readable recording medium storing a program to cause a computer to implement a method, including: receiving analysis data obtained by collecting context information of acquaintances, the acquaintances in the same circumstances as a user among subscribers logged into an online personal networking service, generating an analysis screen related to the acquaintances based on the received analysis data, and displaying the generated analysis screen.

Other features and aspects may be apparent from the following detailed description, the drawings, and the claims.

### BRIEF DESCRIPTION OF THE DRAWINGS

FIG. 1 is a block diagram illustrating a network community providing apparatus for providing a network community service according to an embodiment.

FIGS. 2A to 2E are diagrams illustrating User Interfaces (UIs) to describe an operation by which a user initially registers a device, according to an embodiment.

FIGS. 3A to 3F are diagrams illustrating UIs to describe an operation of setting context information using an initial screen containing an acquaintance list, and registering a new device, according to an embodiment.

FIG. 4 is a diagram illustrating a UI showing a list of acquaintances logged into a network service, according to an embodiment.

FIG. 5 is a diagram illustrating a UI showing a list of acquaintances that are in the same circumstances as a user, according to an embodiment.

FIG. 6 is a diagram illustrating a program screen on which the UI of FIG. 5 is superimposed.

FIG. 7 is a diagram illustrating an example of an analysis screen displayed when an “Analysis screen” button is selected from the program screen of FIG. 6.

FIGS. 8A and 8B are diagrams illustrating another examples of the analysis screen displayed when the “Analysis screen” button is selected from the program screen of FIG. 6.

FIG. 9 is a flowchart illustrating an example of an operation of registering a new device in a network community providing method, according to an embodiment.

FIG. 10 is a flowchart illustrating another example of the operation of registering a new device in a network community providing method, according to an embodiment.

FIG. 11 is a flowchart illustrating an example of an operation of displaying an analysis screen in a network community providing method, according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

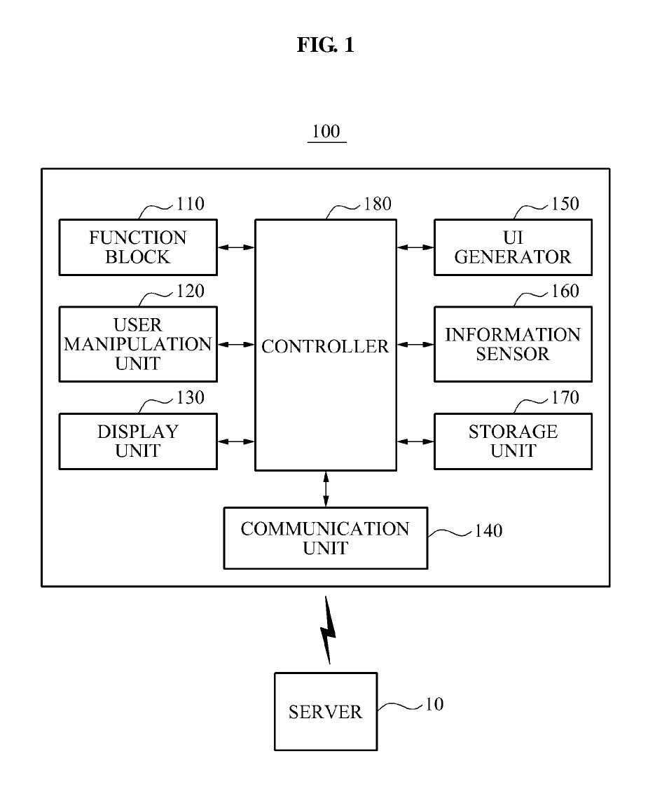

FIG. 1 illustrates a network community providing apparatus 100 for providing a network community service according to an embodiment.

The network community providing apparatus 100 may be implemented by any device enabling Internet networking, for example a mobile device, a digital television (DTV) and the like. The network community providing apparatus 100 may include a function block 110, a user manipulation unit 120, a display unit 130, a communication unit 140, a User Interface (UI) generator 150, an information sensor 160, a storage unit 170, and a controller 180.

The function block 110 may perform original functions of the network community providing apparatus 100. For example, in response to a portable terminal being used as the network community providing apparatus 100, the function block 110 may perform functions provided by the portable terminal. In response to a DTV being used as network community providing apparatus 100, the function block 110 may perform functions provided by the DTV.

The user manipulation unit 120 may provide interfacing between a user and the network community providing apparatus 100. The user manipulation unit 120 may receive a predetermined manipulated command from the user, and may be implemented by a button, a key, a mouse wheel, a touch screen, and the like.

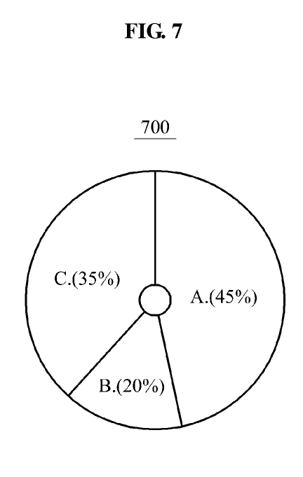

The display unit 130 may display various UIs to provide to a user. For example, the display unit 130 may display an analysis screen as shown in FIG. 7. The analysis screen may be related to acquaintances that are in the same circumstances as a user, are placed in the same environment as the user, and have the same object as the user among subscribers logged into an online personal networking service (hereinafter, is referred to as a “network service”). The acquaintances may be people currently logged into the network service among all people registered in an address book of the user.

The communication unit 140 may be communicably connected via a network such as the Internet to a server 10 and devices (not shown) used by acquaintances. The communication unit 140 may transmit sound energy or movement data to the server 10. The sound energy or movement data may be sensed by the information sensor 160. The communication unit 140 may periodically receive from the server 10 analysis data obtained by collecting context information of acquaintances or subscribers currently logged into the network service. Alternatively, the communication unit 140 may receive the analysis data from the server 10 upon a user requests to display the analysis screen.

The analysis screen refers to a UI which may visualize analysis data with context information such as reactions or current states of acquaintances or subscribers that are in the same circumstances as the user. The analysis screen may be, for example, represented by a graphic. For example, when a user and acquaintances view the same content, the server 10 may prepare analysis data by analyzing reactions of the acquaintances to the content.

The server 10 may be used to provide the network service, and may include, for example, a web server to provide a Social Network Service (SNS). The server 10 may communicably connect to devices used by the subscribers or acquaintances, may receive context information of the subscribers or acquaintances from the devices, may prepare analysis data based on the received context information, and may transmit the prepared analysis data to the communication unit 140 in real-time. Nonlimiting examples of the context information may include sound energy, movement data, or location information.

The server 10 may receive the context information, e.g., sound energy or movement data. The sound energy may be sensed, e.g., by sound sensors included in the devices used by the acquaintances, and/or by a sound sensor included in the network community providing apparatus 100, and the movement data may be sensed, e.g., by a photography apparatus, for example, a camera, a photosensor, etc. The server 10 may analyze the received sound energy or movement data, and may then prepare analysis data showing reactions of the acquaintances.

Alternatively, in response to the user's and acquaintances' performing the same activity, the server 10 may prepare analysis data with a regional distribution chart of the acquaintances.

The UI generator 150 may generate a UI corresponding to a user command under the control of the controller 180, and may display the generated UI. In response to a user's requesting an analysis screen showing acquaintances that are in the same circumstances as the user, the UI generator 150 may generate an analysis screen based on the analysis data provided by the server 10.

For example, in response to a user's and acquaintances' viewing the same content, the UI generator 150 may receive from the server 10 the analysis data obtained by analyzing reactions of the acquaintances to the content, and may generate an analysis screen based on the received analysis data, as shown in FIG. 7. Alternatively, in response to a user's and acquaintances' performing the same activity, the UI generator 150 may receive from the server 10 the analysis data with the regional distribution chart of the acquaintances, and may generate an analysis screen based on the received analysis data.

The information sensor 160 may include a sound sensor to sense a sound energy of a user, and a photography apparatus to sense a movement of the user. Alternatively, the information sensor 160 may sense both the movement and sound energy of the user using a microphone included in the photography apparatus. Other appropriate sensing may also be performed. The information sensor 160 may provide the server 10 with the sensed sound energy or movement, so that the sound energy or movement may be used as analysis data.

The storage unit 170 may store a plurality of contents, the analysis data provided by the server 10, and a program used to operate the network community providing apparatus 100. Contents may be downloaded by the network community providing apparatus 100 from an external device, or may be generated automatically by the network community providing apparatus 100. The storage unit 170 may be implemented by a hard disc, a nonvolatile memory, and the like.

The controller 180 may control an overall operation of the network community providing apparatus 100 based on a user request received by the user manipulation unit 120. In response to a user's requesting initiation of the network service, the controller 180 may control generation and display of a variety of UIs, such as a UI used to perform login, a UI used to record a current context or current state of a user on the network service, and an analysis screen used to visualize analysis data.

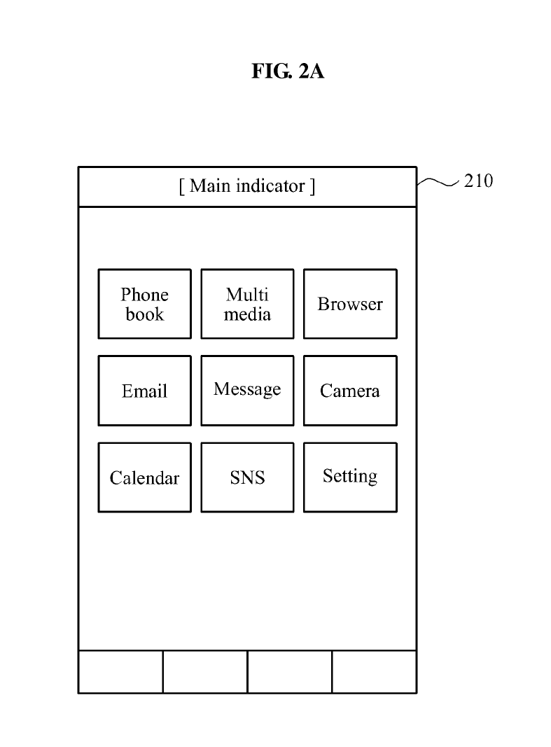

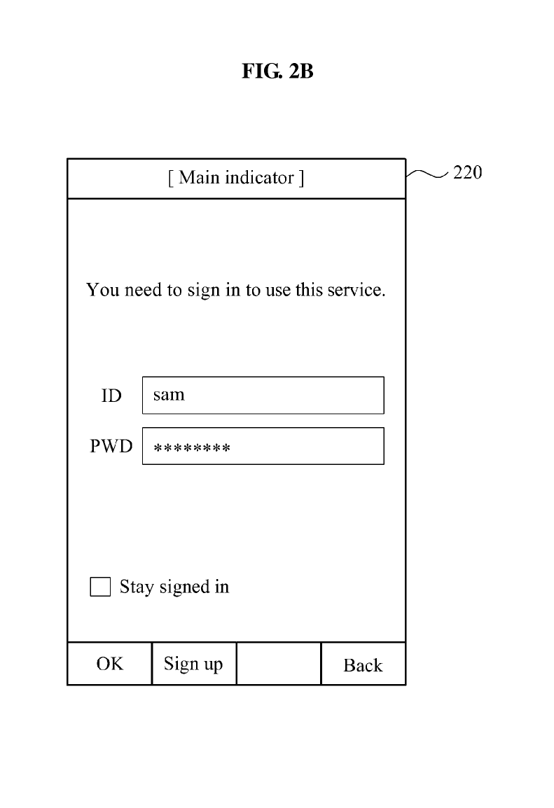

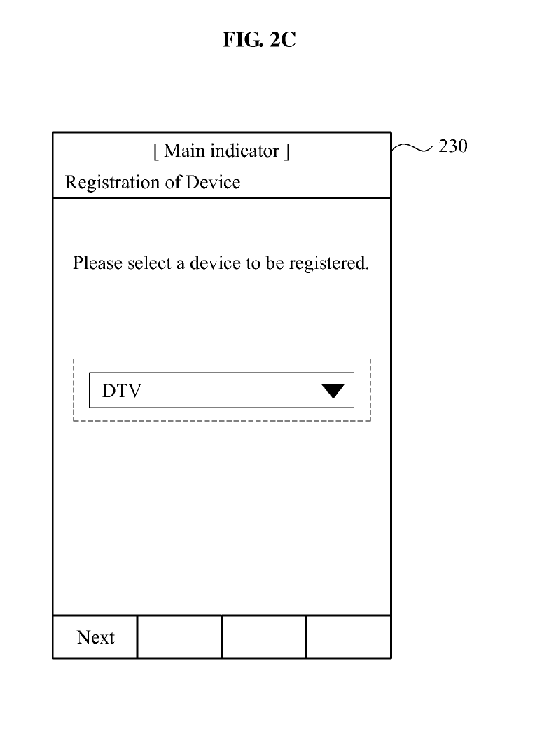

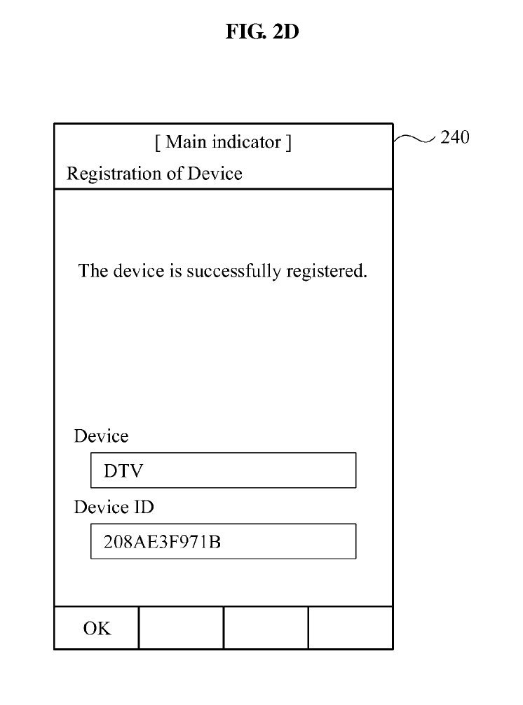

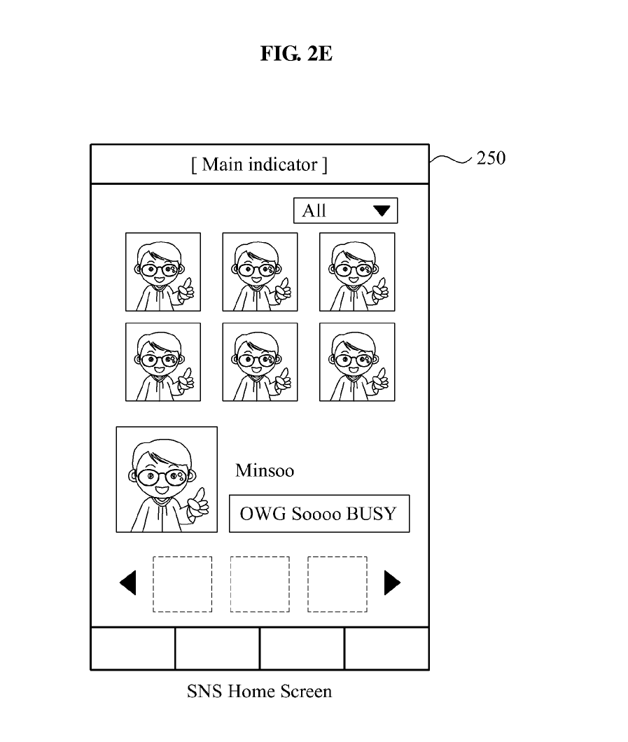

An example where a user uses a network service will be further described with reference to FIGS. 2A to 2E.

FIGS. 2A to 2E illustrate UIs to describe an operation by which a user initially registers a device.

A user may first register the network community providing apparatus 100 through a website via a computer. When the network community providing apparatus 100 is registered as a device of the user, the user may register other devices as new devices using the computer or the network community providing apparatus 100. The UIs shown in FIGS. 2A to 2E may be displayed on the network community providing apparatus 100 or on a web page. An operation by which the network community providing apparatus 100 may be used to register a new device will be described, however, any Internet-accessible device may be used to register a new device.

The user may install or remove an application program which supports the network service. The application program may include, for example, a widget. The display unit 130 may display a UI 210 to show icons representing various application programs which are installed in the network community providing apparatus 100, as shown in FIG. 2A.

For example, in response to the user's selecting an “SNS” icon from the UI 210, the UI generator 150 may generate a UI 220 used to perform a login, as shown in FIG. 2B. The SNS is representative of the network service, and the network service may be applied and utilized in a variety of fields, for example, may be used as a function of a messenger.

In response to the user's entering his or her identification (ID) or password (PWD) through the UI 220, the UI generator 150 may generate a UI 230 which enables the user to select a device to be registered, as shown in FIG. 2C. For example, when the user desires to register a DTV, a “DTV” item may be selected from the UI 230.

In response to the user's selecting the “DTV” item, the UI generator 150 may generate a UI 240 used to input a device ID, as shown in FIG. 2D. In response to the user's entering a serial number or manufacturing number of the device to be registered, the device may be completely registered. Attribute information of the registered device may be transmitted to the server 10. For example, the attribute information of the registered device may be, for example, an ID of the device or a registration date of the device.

The UI generator 150 may generate an SNS Home Screen 250, as shown in FIG. 2E. The SNS Home Screen 250 may be an initial screen used to perform the network service. The SNS Home Screen 250 may show an acquaintance list of acquaintances currently logged into the network service among acquaintances of the user, and user information, such as a user's ID, a blurb, and the like.

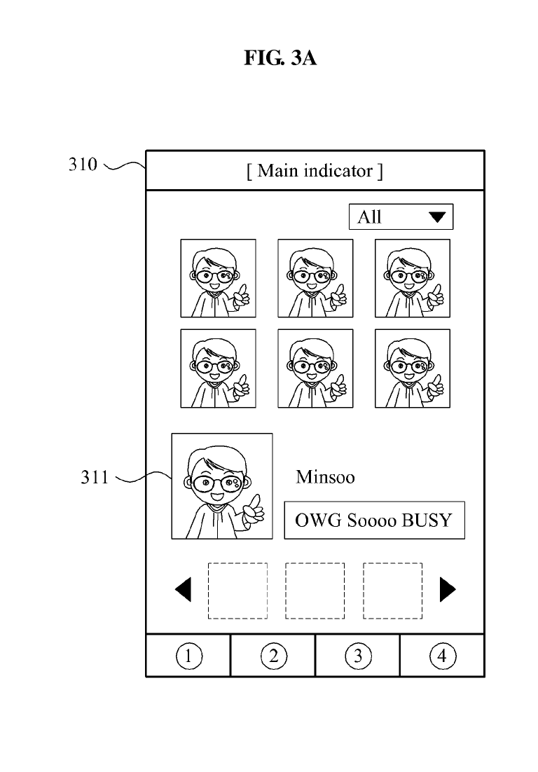

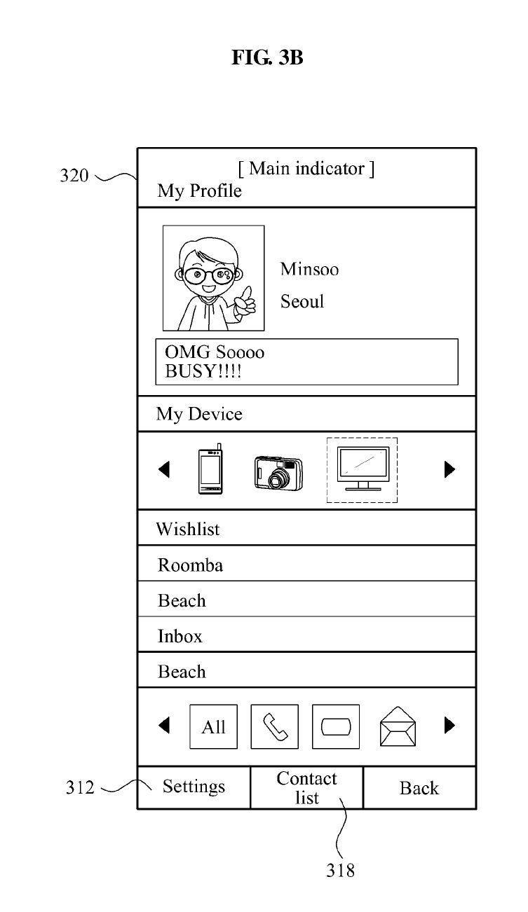

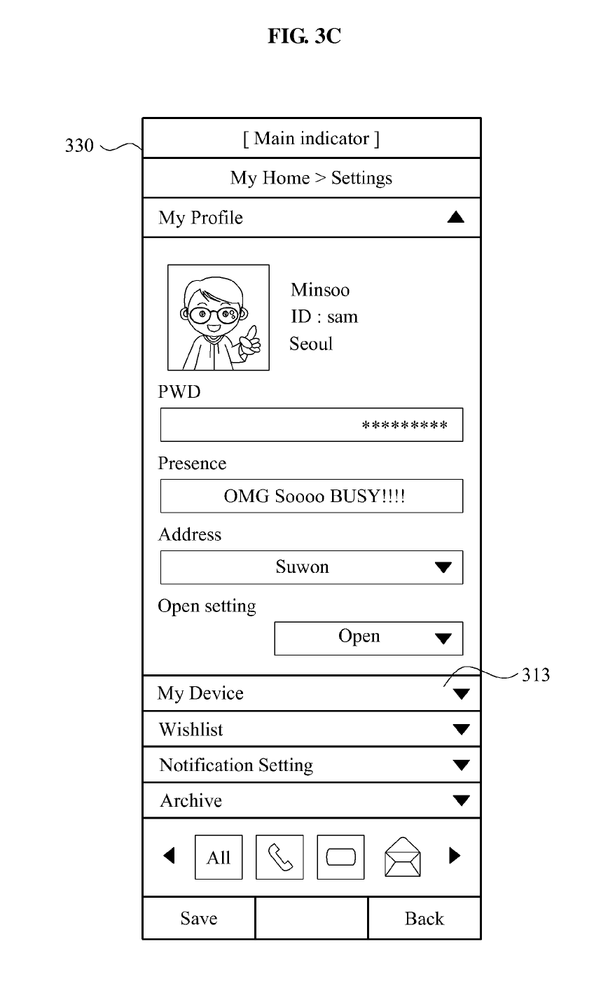

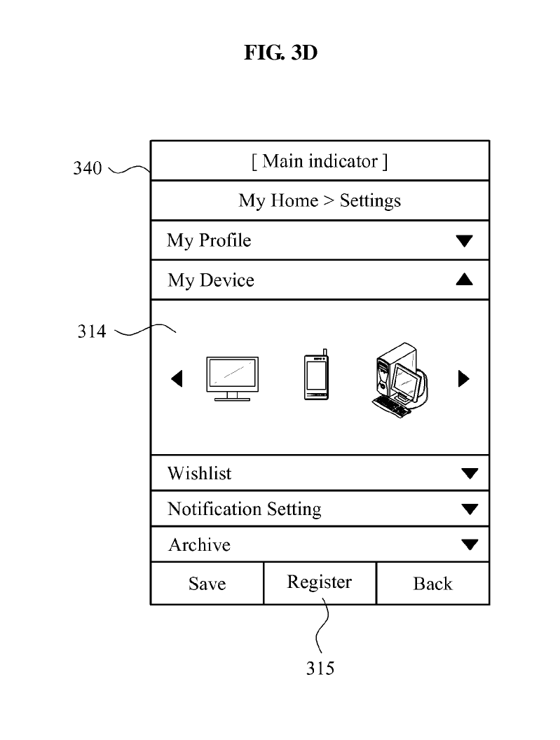

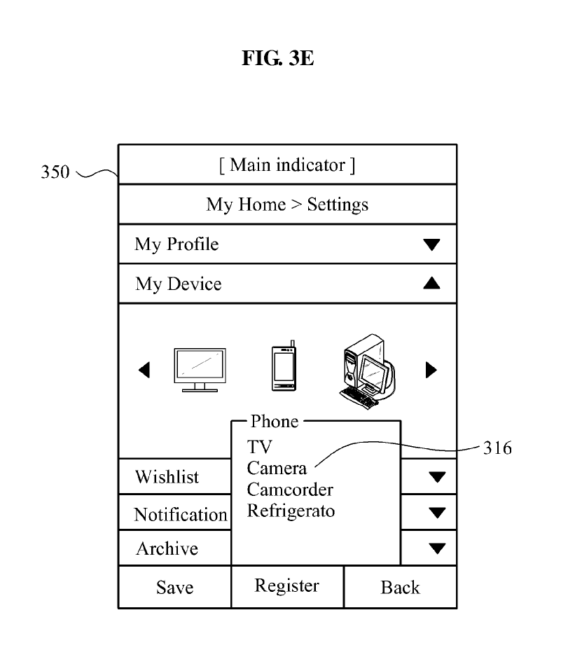

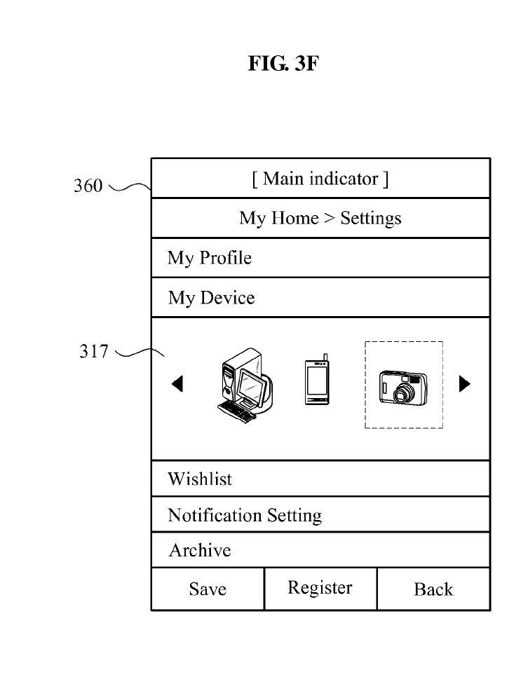

FIGS. 3A to 3F illustrate UIs to describe an operation of setting context information using an initial screen 310 containing the acquaintance list, and registering a new device.

To check a user context on the initial screen 310 of the network service, the user may select user's regions, for example a user's photo 311. The UI generator 150 may generate a UI 320 showing a current user context, as shown in FIG. 3B.

In response to the user's selecting a “Settings” button 312 from the UI 320 to edit his or her context, the UI generator 150 may generate a UI 330 as shown in FIG. 3C, so that the user may set a current state, an address, or whether to open user context of the user to the public through the UI 330.

In response to the user's selecting a “My Device” item 313 from the UI 330, the UI generator 150 may generate a UI 340 showing an icon list 314 of icons representing devices used by the user, as shown in FIG. 3D.

In response to the user's selecting a “Register” button 315 from the UI 340, the UI generator 150 may generate a UI 350 on which a device list is superimposed as shown in FIG. 3E, so that the user may select a desired device 316 from the device list to register the selected device 316. For example, in response to the user's selecting the device 316, the UI generator 150 may generate a UI 360 showing a new icon list 317 in which an icon representing the selected device 316 is added, as shown in FIG. 3F. As such, the user may use the network service using one of the devices displayed on the icon list 317.

As described above, the UIs 210 to 250 and 310 to 360 may be provided through a web page in the same manner as or a similar manner to the network community providing apparatus 100. As such, the user may register a desired device as a new device, and may be provided with the network service using the registered device. Also, a list of devices registered by the user may be shared between all the devices.

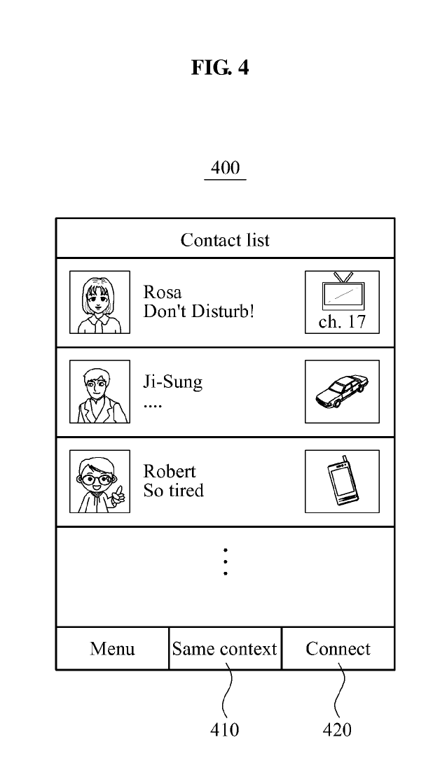

In response to the user's selecting a “Contact list” button 318 from the UI 320 shown in FIG. 3B, the UI generator 150 may generate a contact list UI 400 as shown in FIG. 4. The contact list UI 400 may show acquaintances currently logged into the network service among all the acquaintances registered in the address book of the user.

The user may be aware that an acquaintance, Rosa, is watching a broadcast on channel 17, and another acquaintance, Ji-Sung, is driving, using the contact list UI 400 shown in FIG. 4. In this instance, in response to Rosa's changing the current channel, information on the changed channel may be displayed on the contact list UI 400. In response to a location of Ji-Sung being changed, a name of the changed location may also be displayed on the contact list UI 400 as devices used by the acquaintances, the server 10, and the network community providing apparatus 100 of the user continue to communicate with each other.

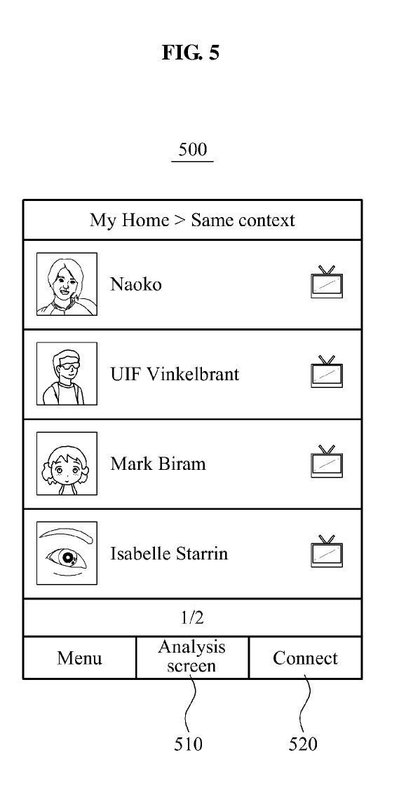

In response to the user's selecting a “Same context” button 410 from the contact list UI 400, the UI generator 150 may generate a UI 500 showing only the acquaintances that are currently in the same circumstances as the user, as shown in FIG. 5. For example, when the user is watching a program on channel 17 in a TV, only acquaintances currently watching the program on channel 17 may be displayed on the UI 500 of FIG. 5.

The network community providing apparatus 100 may request a list of the acquaintances that are currently in the same circumstances as the user, and may re-receive the list from the server 10. Alternatively, the controller 180 may extract the acquaintances that are currently in the same circumstances as the user from the contact list UI 400. The UI generator 150 may generate the UI 500 which may include information on devices used by the acquaintances and one of the list received from the server 10 and a list of the acquaintances extracted by the controller 180. It may be possible for the user to know who is watching channel 17.

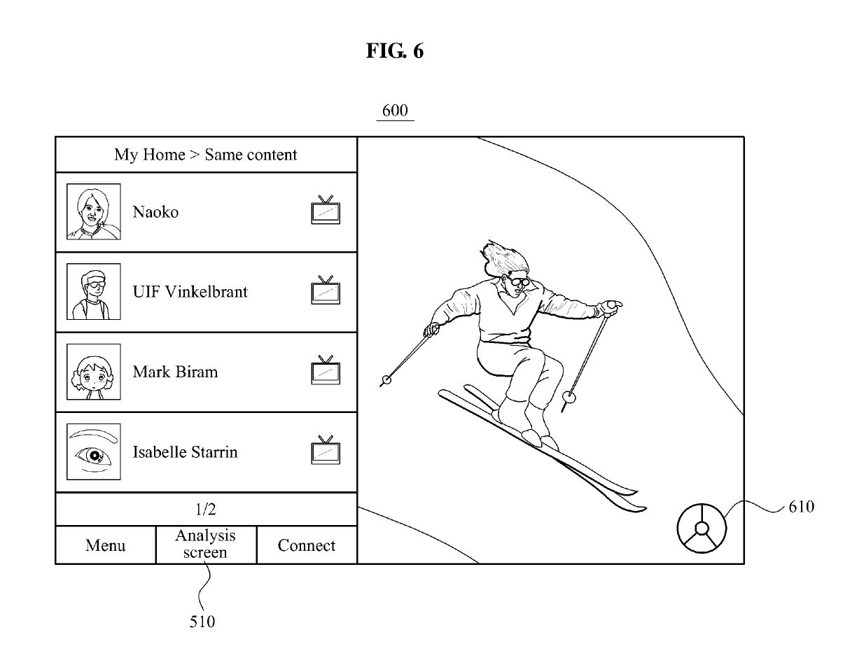

In response to a TV being used as the network community providing apparatus 100, the UI 500 may be superimposed with channel 17 on a program screen 600 so that the user may watch both, as shown in FIG. 6. An “Analysis screen” button 510 of the program screen 600 may enable the user to request a display of a UI to visualize analysis data that has been obtained by analyzing reactions and current states of acquaintances or subscribers that are in the same circumstances as the user.

In response to the user's selecting the “Analysis screen” button 510 from the program screen 600 of FIG. 6, the UI generator 150 may generate a UI displaying an analysis screen 610 based on reactions of acquaintances to a currently viewed program and current states of the acquaintances. In response to the user's also requesting a display of reactions and current states of all the subscribers, the UI generator 150 may generate a UI (not shown) to display the reactions and current states of all the subscribers watching channel 17. The analysis screen may be displayed in various display modes. For example, the analysis screen may be displayed by a reaction, continent, region, gender, or age. The user may select a desired display mode by manipulating a direction key on the user manipulation unit 120, and a touch screen.

FIG. 7 illustrates an analysis screen displayed when the “Analysis screen” button is selected from the program screen of FIG. 6.

The analysis screen 700 shown in FIG. 7 may be displayed in response to a reaction display mode being selected. The analysis screen 700 may show a percentage of reactions of acquaintances to channel 17. The server 10 may receive sound energy sensed by sound sensors included in devices used by the acquaintances and by a sound sensor included in the network community providing apparatus 100, or may receive movement data sensed by the photography apparatus. Other appropriate sensing results may also be received. The server 10 may then analyze each reaction of the acquaintances based on the sensed sound energy or movement data, and may determine a degree to which the acquaintances react to channel 17. The UI generator 150 may receive the analysis data prepared by the server 10, and may generate the analysis screen 700 based on the received analysis data, as shown in FIG. 7.

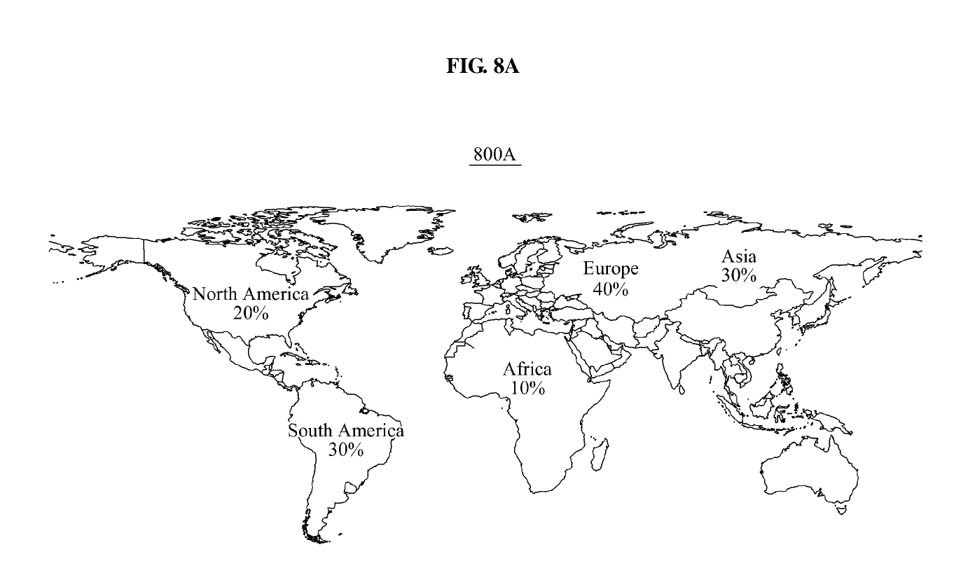

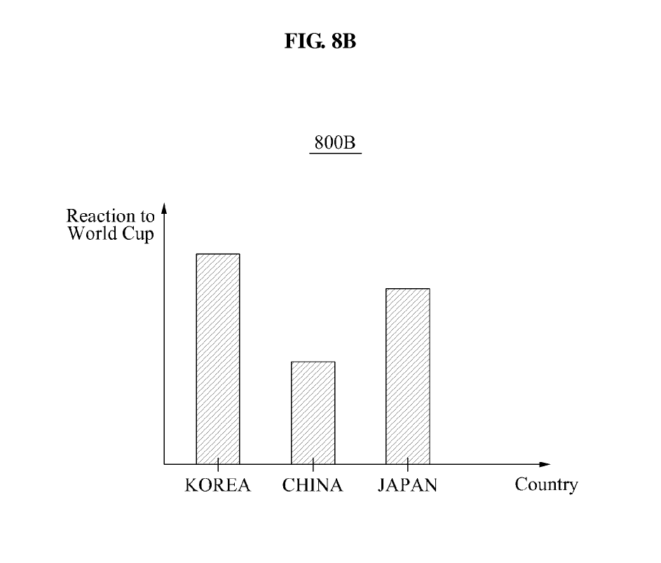

FIGS. 8A and 8B illustrate analysis screens and, respectively.

The analysis screen 800A of FIG. 8A may be displayed when a world display mode is selected. For example, in response to the user's watching a World Cup match, the analysis screen 800A may show reactions to the World Cup match for each continent as shown in FIG. 8A. The reactions to the World Cup match may be represented by an audience rating or by responses to the World Cup match. In one example, in response to the user's selecting the continent of Asia from the analysis screen 800A, the analysis screen 800B may show in greater detail reactions for each country in the continent of Asia, as shown in FIG. 8B.

A user may request a conversation with an acquaintance by selecting a “Connect” button 420 of the UI 400 or a “Connect” button 520 of the UI 500. The user may check information regarding acquaintances through the UI 400 in real-time. In response to the acquaintance's accepting a user's conversation request, the user may talk with the acquaintance or share contents stored in a device of the acquaintance using a device used by the acquaintance to perform a login, or using other available devices.

In response to the acquaintance's accepting the user's conversation request while watching a TV program, the controller 180 may select a currently viewed channel of the acquaintance, and may enable the user to watch the selected channel on the TV. Alternatively, in another example, the controller 180 may enable the user to talk via a Voice over Internet Protocol (VoIP) with the acquaintance using the same application as that provided by the TV of the acquaintance.

In response to one of currently logged-in acquaintances' requesting a conversation with the user, the controller 180 may recommend a conversation scheme to the user based on a user context, or may automatically select an appropriate conversation scheme. For example, the user context may include a current state of the user or information regarding whether the user is able to talk over the telephone. Table 1 shows examples of a conversation scheme recommended depending on the user context.

TABLE 1

| | | Recommended conversation |
|---|---|---|
| Product | Context | scheme |
| TV | Watching (alone in front of | Talk via VoIP over TV |
| | TV) | |
| | Watching (away) | Send message to TV |
| | Watching (several people) | Recommend personal mobile |
| | | phone |
| Mobile | Talking over phone | Send message |
| Phone | (automatically detecting) | |
| | Watching moving image | Send message |
| | (automatically detecting) | |
| | Listening to music | Send message |
| | (automatically detecting) | |
| | Not doing anything | Talk over phone |
| | (automatically detecting) | |
| | Exercising (setting task) | Send message |
| | Participating in conference | Send message |
| | (setting task) | |
| | Feeling bored (setting | Talk over phone |
| | emotion) | |
| Navigation | Driving (vehicle is moving) | Send message to navigation |
| system | | system |
| | Driving (vehicle is stopped | Talk via VoIP over navigation |
| | for two minutes or longer) | system |
| | Watching DMB while | Send message to navigation |
| | driving | system |
| PMP, PC | Watching DMB | Send message |
| | Watching a moving image | Send message |
| | (automatically detecting) | |
| | Listening to music | Send message |
| | (automatically detecting) | |
| | Using PC | Chatting |

For example, in response to the request for the acquaintance to talk to the user being received through the communication unit 140, the controller 180 may check the current state of the user. When determining the user is watching TV alone as a result of checking the photography apparatus of the information sensor 160, the controller 180 may recommend to the user a conversation scheme to talk via VoIP over the TV. The controller 180 may prepare an On-Screen-Display (OSD) message, and may display the OSD message on the display unit 130. In response to the user's accepting the recommendation of the controller 180, the controller 180 may provide the user with an environment which enables the user to talk over the VoIP with the acquaintance by communicably connecting a device of the user to the device of the acquaintance.

Alternatively, in response to the acquaintance's requesting a conversation with the user while the user is talking over the mobile phone, the controller 180 may automatically send a message to the device of the acquaintance informing that the user is talking over the phone.

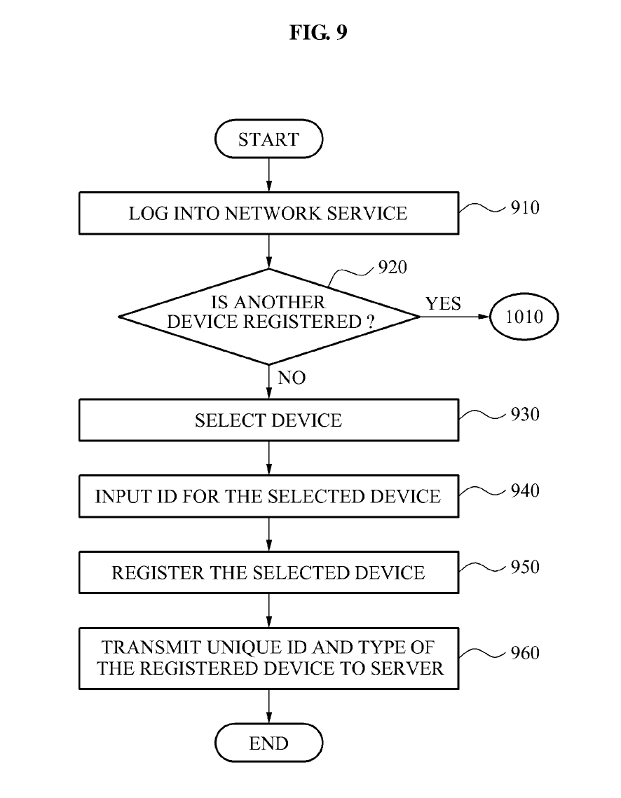

FIG. 9 illustrates an operation of registering a new device in a network community providing method.

In operation 910, a user may log into a network service through the network community providing apparatus 100 or through the UI 220 on the computer. The UI 220 may be displayed using a widget program of the network community providing apparatus 100, or may be displayed on a web page.

In operation 920, in response to another device registered by the user existing, operation 1010 may be performed.

Alternatively, in response to there being no device registered by the user, the user may select a device through the UI 230 appearing on the display unit 130 in operation 930.

In operation 940, the user may enter a unique ID for the selected device through the UI 240. For example, the unique ID may include a serial number of the device or a Media Access Control (MAC) address of the device.

When registration of the device in operation 950 is completed, the unique ID and a type of the registered device may be transmitted to the server 10 in operation 960. The server 10 may store and manage the type of devices and IDs of devices for each user.

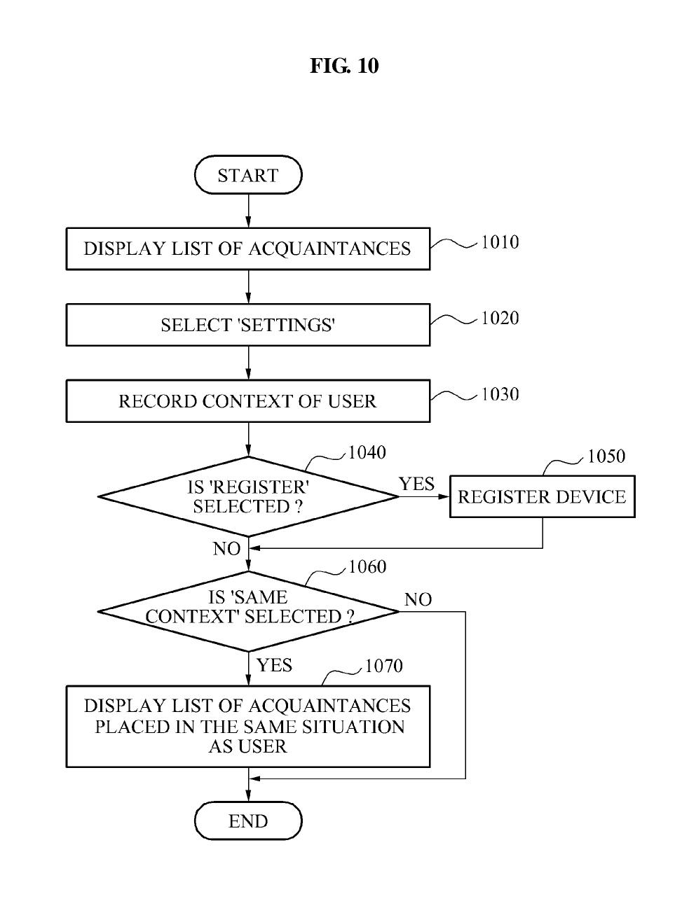

FIG. 10 illustrates an operation of setting context information using an initial screen of a network service and registering a new device, in a network community providing method.

In operation 1010, an initial screen 310 may be displayed on the display unit 130 to show the user information and the list of acquaintances currently logged into the network service among the acquaintances of the user.

In response to the “Settings” button 312 being selected to check and edit the user context in operation 1020, the user may edit or record the context using the UI 320 in operation 1030.

By selecting the “Register” button 315 after the UIs 330 and 340 are sequentially displayed in operation 1040, the user may register a new device using the UI 350 in operation 1050. In one example, the user may also record a unique ID for the new device.

In response to the user's selecting the “Same context” button 410 through the UI 400 appearing on the display unit 130 in operation 1060, the UI 500 may be displayed on the display unit 130 to show the list of the acquaintances in the same circumstances as the user in operation 1070. Accordingly, it may be possible to provide the user with information regarding the acquaintances through the UI 500 in real-time.

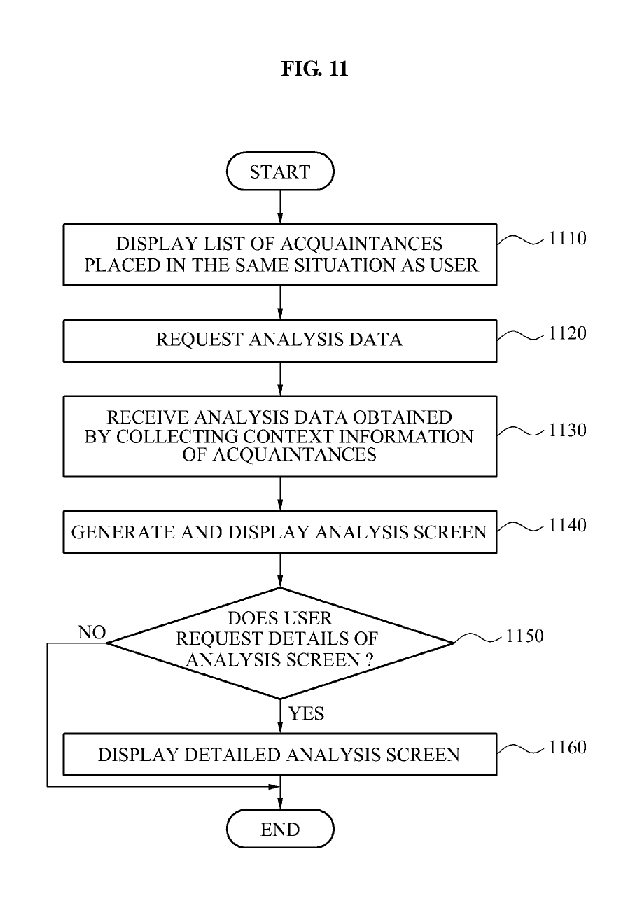

FIG. 11 illustrates an operation of displaying an analysis screen in a network community providing method.

In operation 1110, the UI 500 may be displayed on the display unit 130 to show the list of the acquaintances in the same circumstances as the user.

In operation 1120, in response to the user's selecting the “Analysis screen” button 510 from the UI 500, the controller 180 may request the server 10 to transmit analysis data related to the acquaintances in the same circumstances the user.

In operation 1130, the communication unit 140 may receive the analysis data from the server 10. For example, the analysis data may be obtained by collecting context information of the acquaintances, as described above.

In operation 1140, the controller 180 may control the UI generator 150 and the display unit 130 to generate the analysis screens 700, 800A, and 800B based on the received analysis data and to display the generated analysis screens 700, 800A, and 800B.

In operation 1150, in response to the user's requesting details of the displayed analysis screen, for example the analysis screen 800A of FIG. 8A, the controller 180 may control the UI generator 150 and the display unit 130 to generate the detailed analysis screen 800B based on the received analysis data and to display the generated analysis screen 800B, as shown in FIG. 8B.

The UI generator 150 may generate the detailed analysis screen 800B so that the detailed analysis screen 800B may be displayed on the display unit 130. The analysis screen 800A or the detailed analysis screen 800B may be displayed in various forms or with various themes according to a display mode selected by the user. The various forms may include, for example, a bar graph, a pie chart, a map, and the like. The various themes may be, for example, a response level (high, middle, and low), an audience rating, and the like.

As described above, according to an apparatus and method for providing a network community service, a user may register all available devices, and it may be possible to provide the user with an online personal networking service using his or her mobile phone.

Also, a function of networking between devices may be extended, and accordingly, it is possible to provide the user with an SNS in real-time. For example, the SNS may reflect a real-time context of the user and provide information on a device currently used by the user. Thus, it is possible for the user to check contexts of acquaintances that are dynamically changing, and to notify the acquaintances of a user context of the user.

A device of a user may be communicably connected to a device of an acquaintance, and thus it is possible to share information regarding a current state of the user with the acquaintance, and to share contents between the user and the acquaintance, or to browse through a partner's device.

It is possible to recommend an appropriate scheme for conversation between a user and an acquaintance based on the context of the user, and it is also possible to communicably connect a device of the user directly to a device of the acquaintance.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing a network community service, the apparatus comprising:
a display unit configured to display an analysis screen related to acquaintances, the acquaintances in the same circumstances as a user among subscribers logged into an online personal networking service; and
a User Interface (UI) generator configured to:
receive analysis data; and
generate the analysis screen based on the received analysis data, the analysis data being obtained by collecting context information of the acquaintances.

2. The apparatus of claim 1, wherein the analysis data comprises context information of subscribers in the same circumstances as the user among the subscribers logged into the online personal networking service.

3. The apparatus of claim 1, wherein the analysis data is provided by a server configured to provide the online personal networking service.

4. The apparatus of claim 3, further comprising:
a communication unit configured to communicate with the server and devices used by the acquaintances,
wherein the server is further configured to:
receive the context information of the acquaintances from the devices used by the acquaintances,
prepare the analysis data, and
transmit the prepared analysis data to the communication unit in real-time.

5. The apparatus of claim 1, wherein, in response to the acquaintances' and the user's viewing the same content, the analysis screen is further configured to show a result of analyzing a reaction of the acquaintances to the content.

6. The apparatus of claim 5, wherein the reaction of the acquaintances is analyzed based on sound energy or movement data, the sound energy, or movement data being generated while the acquaintances view the content.

7. The apparatus of claim 6, further comprising at least one of:
a sound sensor configured to sense a sound energy of the user; and
a photography apparatus configured to sense a movement of the user.

8. The apparatus of claim 1, wherein, in response to the acquaintances' and the user's performing the same activity, the analysis screen is further configured to show a regional distribution chart of the acquaintances.

9. The apparatus of claim 1, wherein the display unit is further configured to display a UI containing a list of the acquaintances and information regarding the devices used by the acquaintances.

10. The apparatus of claim 1, further comprising a controller configured either to recommend a conversation scheme to the user based on a context of the user, or to automatically select the conversation scheme, in response to one of the acquaintances' requesting a conversation with the user.

11. A method for providing a network community service in a network community providing apparatus, the method comprising:
receiving analysis data obtained by collecting context information of acquaintances, the acquaintances in the same circumstances as a user among subscribers logged into an online personal networking service;
generating an analysis screen related to the acquaintances based on the received analysis data; and
displaying the generated analysis screen.

12. The method of claim 11, wherein the analysis data comprises context information of subscribers in the same circumstances as the user among the subscribers logged into the online personal networking service.

13. The method of claim 11, wherein the analysis data is provided by a server which provides the online personal networking service.

14. The method of claim 13, wherein the server:
receives the context information of the acquaintances from the devices used by the acquaintances;
prepares the analysis data; and
transmits the prepared analysis data in real-time.

15. The method of claim 11, wherein, in response to the acquaintances' and the user's viewing the same content, the analysis screen shows a result of analyzing a reaction of the acquaintances to the content.

16. The method of claim 15, wherein the reaction of the acquaintances is analyzed based on sound energy or movement data, the sound energy or movement data being generated while the acquaintances view the content.

17. The method of claim 16, further comprising:
sensing, by a sound sensor, a sound energy of the user; or
sensing, by a photography apparatus, a movement of the user.

18. The method of claim 11, wherein, in response to the acquaintances' and the user's performing the same activity, the analysis screen shows a regional distribution chart of the acquaintances.

19. The method of claim 11, further comprising displaying a UI containing a list of the acquaintances and information regarding the devices used by the acquaintances.

20. The method of claim 11, further comprising, when one of the acquaintances requests a conversation with the user:
recommending a conversation scheme to the user based on a context of the user; or
automatically selecting the conversation scheme.

21. A computer-readable recording medium storing a program to cause a computer to implement a method, comprising:
receiving analysis data obtained by collecting context information of acquaintances, the acquaintances in the same circumstances as a user among subscribers logged into an online personal networking service;
generating an analysis screen related to the acquaintances based on the received analysis data; and
displaying the generated analysis screen.
